(19) United States
(12) Patent Application Publication
(10) Pub. No.: US 2013/0255593 A1
(43) Pub. Date: Oct. 3, 2013

(54) SYSTEM AND METHOD FOR FACILITATING THE SELECTION OF LIVESTOCK ANIMALS REQUIRING ACTION

(71) Applicant: Dan Hilarides, Tulare, CA (US)

(72) Inventor: Dan Hilarides, Tulare, CA (US)

(21) Appl. No.: 13/434,780

(22) Filed: Mar. 29, 2012

(51) Int. Cl. A01K 29/00

(52) U.S. Cl. 119/840

(57) ABSTRACT

A system facilitates the selection of livestock animals requiring action from group of livestock animals. The system includes a tag, a power supply, a signal receiver, lights, a signal transmitter and an electronic computing device. By sending a signal through the transmitter, the electronic computing device is able to illuminate one or more of the lights to visually identify an animal wearing the tag. In this way, a user may easily identify and select for action, one or more livestock animals.

### BACKGROUND OF THE INVENTION

Application of RFID technology has taken a rapid development in agriculture, specifically with regard to the management of livestock on a farm. It has become quite common to provide animals with an RFID tag. RFID tags have been proposed in many different forms and with many different options, not only to allow for identification of livestock but also for process control. As is known in the field of livestock such a tag can be an ear tag but other tags such as collar tags are well known.

In order to support objectives of obtaining high-quality livestock, the handler is interested in collecting and using information such as identifying and tracking individual animals as they move, recording periodic weight measurements, recording vaccinations and other significant events in the maintaining of the livestock animal in order to track the success of treatments as well as to eliminate duplicate treatments. Because animals at different stages of care require different treatments, medication, feed, etc. it is critical to carefully identify and select the appropriate animals for treatment, medication, fee, etc.

While RFID technology has greatly facilitated the tracking of livestock animals and recording of information relevant to their care and harvesting, all known systems still require the visually identify an animal or individual animal RFID scanning in order to single it out for the necessary care. This process frequently takes time and often results in selection mistakes. A need exists for facilitating selection of one or more livestock animals from a larger group of livestock animals.

### SUMMARY OF THE INVENTION

The present invention facilitates the selection of one or more livestock animals from a larger group of livestock animals by providing one or more colored lights on a livestock radio-frequency identification (RFID) tag. In this way, a signal may be communicated to the RFID tags of the particular animals according to their need for treatment and the RFID tag will respond by activating one or more colored lights to provide a visual signal to a livestock handler indicating the animal needed for selection.

By use of the system and method of the present invention, stress on livestock animals may be reduced since animals will be locked up for shorter periods of time, less man power is required as a result of eliminating the need to manually mark all animals, animals are easily identified without locking up all animals and animal selection may take place at night. Furthermore, for lactating animals increase milk production may result from the animals spend more time resting rather than standing and waiting. Because there is no need to search through paperwork to determine medication or supplement dosage, animals may be treated faster. Additionally, the need for painstick or cowchalk is eliminated further reducing operating costs.

### BRIEF DESCRIPTION OF THE DRAWINGS

FIG. 1 illustrates a RFID tag and computer system in accordance with the present invention.

FIG. 2 illustrates a front perspective view of the present invention.

FIG. 3 illustrates a rear perspective view of the present invention.

FIG. 4 illustrates a front perspective view of the invention in accordance with a second embodiment of the present invention.

FIG. 5 illustrates a rear perspective view of the invention in accordance with the embodiment of FIG. 5.

### DETAILED DESCRIPTION OF THE INVENTION

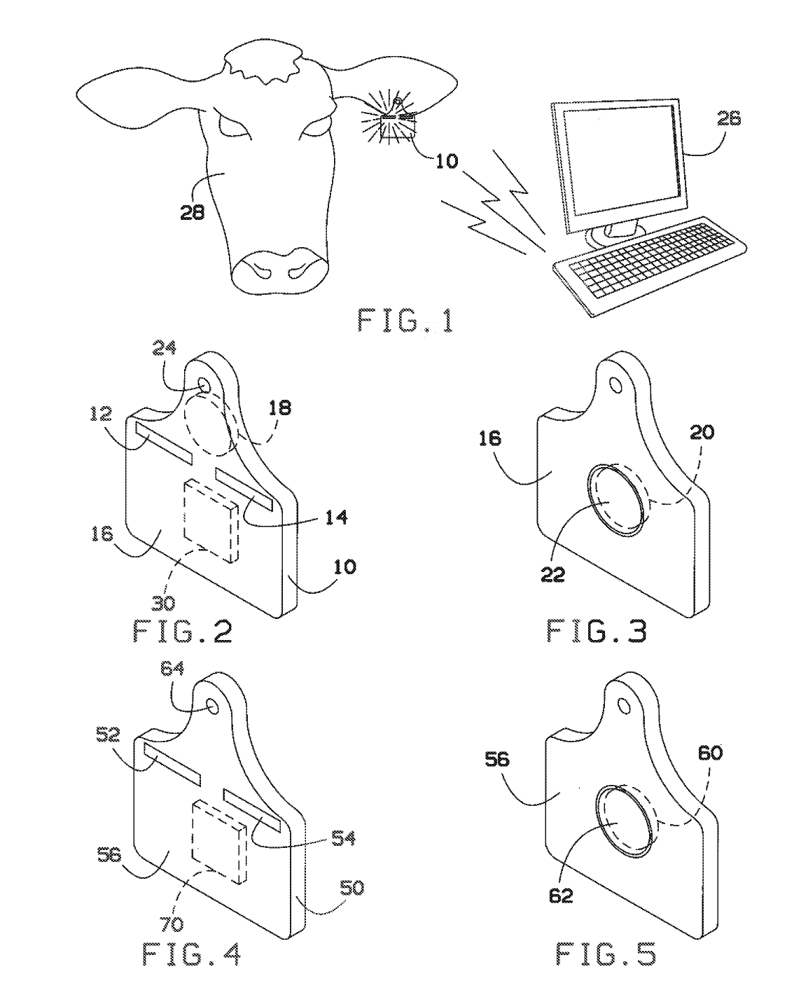

The system of the present invention includes a tag 10 with a body portion to which an animal identification number may be supplied and an attachment portion that is intended to be fastened to a portion of the body of a livestock animal. As depicted in FIG. 1 the body part is preferably an ear. Referring to FIG. 2, a power supply 20 is provided in the body portion of tag 10 along with a signal receiver 30. A signal transmitter is incorporated into an electronic computing system remote from tag 10 and is capable of sending a signal from a processor of the electronic computing system 26 to signal receiver 30. First 12 and second 14 lights are mounted on the tag body. Lights 12 and 14 are supplied power from power supply 20 and are capable of illumination in response to electrical signals from signal receiver 30. in some embodiments, light 12 illuminates a first color and light 14 illuminates a second color such that different colors of illumination may represent different actions required by the animals.

While the invention preferably includes two lights which illuminate two different colors, it may be desirable to provide more than two lights or just a single light. In some embodiments, all lights may illuminate the same color.

in the embodiment depicted in FIGS. 1-3, a RFID chip 18 is disposed in tag 10 to allow for identification, by the electronic computing system 26, of one or more individual livestock animals wearing tags 10.

A database installed on a memory component of electronic computing system 26, contains information about livestock animals. The database allows the user to search and sort animal information to obtain a list of animals requiring a particular action.

A second embodiment, as depicted in FIGS. 4 and 5, is similar to the embodiment of FIGS. 1-3 and includes a tag 10, a power supply 60, a signal receiver 70, two lights 52 and 54. The embodiment is also useable with an electronic computing device such as that depicted in FIG. 26 including a searchable and sortable database of animal information. However, the embodiment does not include a RFID chip.

Preferably, programming integrated into the electronic computing device 26 provides an “illuminate” or animal needed signal to electronic device and transmitter 26 such that one or more lights on 12 and 14 or 52 and 54 on tags 10 or 50 illuminate.

In order to use the invention, a number of animals will need to be fitted with tags 10. After tags 10 have been fitted on the animals and are being supplied power, the user may use the programming and the electronic computing device 26 to create or select a list of animals requiring action from a database listing of all animals. Subsequently the software generates a number of “illuminate” or animal needed signals corresponding to the animals wearing tags 10 that correspond to the user's list of animals needed. Each animal needed signal, being transmitted by a transmitter at the electronic computing device, is next sent to receiver 30 which disposed in tag 10 attached to a livestock animal by attachment portion 24. After receiver 30 receives the animal needed signal, the signal is sent to a light mounted on tag 10. In response, lights receiving the signal illuminate to identify the animals requiring action.

Once the animals requiring action have been identified, these animals are separated from the larger group of animals of livestock animals for whatever action is needed by the selected animals. The action may include a medical treatment, administration of pharmaceuticals or supplements, or harvesting.

In embodiments including a RFID chip 18 in tag 10, the identity of animals may be confirmed by receipt, by the electronic computing device and the database, of an identification signal transmitted from RFID chip 18. In this way, the database may be updated to show the animal was collected for the appropriate action needed.

While the preferred embodiments have made reference to use of the invention with livestock animals, many merchandise industries may also benefit from the tag system.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention.

We claim:

1. A system for facilitating the selection of livestock animals from a group of livestock animals, comprising:
a tag having a body portion and an attachment portion;
a power supply provided in said body portion;
a signal receiver disposed in said body portion;
a signal transmitter remote from said tag;
an electronic computing device capable of sending a signal through said transmitter to said signal receiver; and
a first light mounted on said tag body portion and capable of illumination in response to an electrical signal said signal receiver.

2. The system for facilitating the selection of livestock animals in accordance with claim 1, further comprising:
additional lights mounted on said tag body and capable of illumination in response to electrical signals from the signal receiver;
wherein said first light illuminates a first color and wherein said additional lights illuminate colors different from said first color such that different colors of illumination may represent different actions required by said livestock animals.

3. The system for facilitating the selection of livestock animals in accordance with claim 2, further comprising:
a database installed on a memory component of said electronic computing device, said database containing information about said livestock animals which is retrievable by a user such that the user may sort said information to obtain a list of animals requiring a particular action.

4. The system for facilitating the selection of livestock animals in accordance with claim 1, further comprising:
a database installed on a memory component of said electronic computing device, said database containing information about said livestock animals which is retrievable by a user such that the user may sort said information to obtain a list of animals requiring a particular action.

5. The system for facilitating the selection of livestock animals in accordance with claim 3, further comprising:
a radio-frequency identification chip disposed in said body portion.

6. A method for facilitating election of livestock animals from a group of livestock animals, comprising the steps of:
providing an electronic computing device having a display;
generating an animal needed signal at said electronic computing device;
sending said animal needed signal to a receiver disposed in a tag attached to a livestock animal by an attachment portion;
sending said animal needed signal from said receiver to a bight mounted on said tag;
receiving said signal at said light; and
illuminating said light in response to receipt of said animal identifier signal to visually identify an animal needed for treatment.

7. The method for facilitating the selection of livestock animals in accordance with claim 6, further comprising the steps:
separating said animal needed for treatment from said group of livestock animals; and
performing a treatment on aid animal needed for treatment.

8. The method for facilitating the selection of livestock animals in accordance with claim 7, wherein:
said animal needed signal is generated by selecting, from a database presented on the display of the electronic computing device, an identifying label of an animal requiring action.

9. The method for facilitating the selection of livestock animals in accordance with claim 8, further comprising the step:
receiving, at said electronic computing device, an identification signal transmitted from a radio-frequency identification chip disposed in said tag.

10. The method for facilitating the selection of livestock animals in accordance with claim 6, wherein:
said animal needed signal is generated by selecting, from a database presented on the display of the electronic computing device, an identifying label of an animal requiring action.
